(19) United States
(12) Patent Application Publication
(10) Pub. No.: US 2023/0317974 A1
(43) Pub. Date: Oct. 5, 2023

(54) METHOD FOR PRODUCING A GREEN PAPER FOR PRODUCING A GAS DIFFUSION LAYER FOR A FUEL CELL

(71) Applicant: GIESECKE+DEVRIENT CURRENCY TECHNOLOGY GMBH, München (DE)

(72) Inventors: Karlheinz MAYER, Grunenbach (DE); Alexander TANTSCHER, Dresden (DE)

(21) Appl. No.: 18/024,904

(22) PCT Filed: Aug. 31, 2021
(86) PCT No.: PCT/EP2021/025328

§ 371 Date: Mar. 6, 2023

(30) Foreign Application Priority Data
Sep. 7, 2020 (DE) 10 2020 005 481.1

(51) Int. Cl. H01M 8/0243; D21F 11/06; D21F 11/14; D21F 11/00

(52) U.S. Cl. CPC H01M 8/0243; D21F 11/06; D21F 11/14; D21F 11/006

(57) ABSTRACT

A method is provided for producing a green paper for producing a gas diffusion layer (GDL) for a fuel cell. A first paper web is formed, and a second paper web is formed, which are brought together with and rigidly connected to the first paper web while still wet. The first paper web and the second paper web are mixed with metal powder and/or metal fibers and together form the green paper, optionally together with additional components and/or coatings. The final GDL is provided after a binding-removal process, a sintering process, a coating process, a (thermal) deposition process (atomic layer deposition process, ALD), and optionally additional process steps.

The invention relates to a process for producing a green paper for production of a gas diffusion layer (GDL) for a fuel cell.

In a fuel cell of the proton exchange membrane fuel cell (PEMFC) type, also referred to as polymer electrolyte fuel cell, gas distribution to the membrane coated with catalytic platinum (also referred to as CL or catalyst layer) is achieved by means of what is called a bipolar plate (BPP) and the gas diffusion layer (GDL). The entire construction between two bipolar plates is also referred to as membrane-electrode assembly (MEA).

Under catalytic oxidation of hydrogen and oxygen, the fuel cell produces electrical power, water vapor and heat.

For the automotive sector, a GDL that has now become established is one which is produced from a fiber material, for example carbon fibers, and a coated BPP made of steel. The fiber material may take the form of a textile weave/knit or of a fiber mat produced by paper methodology, which is known, for example, from DE 10 2008 042 415 B3. It may also consist of two plies: a fine ply that adjoins the CL, and a coarser ply that adjoins the BPP and the flow field.

The fiber mat produced by paper methodology is referred to as green paper or sintered paper, which is debindered and/or sintered in one of the subsequent operating steps and hence processed further to give a GDL.

A particular drawback in the production of GDLs based on carbon fibers is that carbon fibers and the further processing thereof are associated with relatively high costs. Furthermore, carbon fibers are pressure-sensitive, which can lead to breakage of fibers, which may then possibly damage the CL/PEM. In addition, the carbon fibers can bulge or swell up and penetrate into the channels of the BPP, which reduces the flow of gas and water and worsens the efficiency of the fuel cell. Moreover, the porosity of the GDL is adjustable only to a limited degree, and, in the case of a two-layer GDL with a combination of coarse and fine porosity, at least two additional operating steps are needed.

It is therefore an object of the invention to develop a generic process for producing a green paper for production of a gas diffusion layer (GDL) for a fuel cell so as to remedy the drawbacks of the prior art.

This object is achieved by the features of the independent claim. Developments of the invention are the subject matter of the dependent claims.

According to the invention, a first paper web is formed and a second paper web is formed, and the latter, in the still-moist state, is combined with and firmly bonded to the first paper web. The first paper web and the second paper web preferably include added metal powder and/or metal fibers, and together with any further constituents and/or coatings form the green paper. The ultimate GDL is the result of debindering, sintering, coating, (thermal) deposition of atomic layers (ALD— atomic layer deposition) and any further process steps. After the sintering, all organic constituents of the green paper have been pyrolyzed and hence are no longer present in the GDL; the GDL consists virtually exclusively of a metal framework. It currently appears that the porosity of the metal framework is dependent especially on the fiber density of the paper webs, the (grain) size of the metal powders and/or metal fibers, and added additives.

Filler materials used for the sinter paper may be any microscale metal powders and metal fibers, for example titanium, copper, zinc or rust-free stainless steels, as known from DE 10 2008 042 415 B3. What is important here is that different mixtures are used for the former ply and the cylindrical screen ply, in order to achieve a different porosity of the paper plies. The former ply here should be made finer than the cylindrical screen ply. It is also possible to use nanosize powders in the former ply.

The first and/or second paper web may be produced here in a cylinder paper machine. Alternatively, the first and/or second paper web may also be produced in a short former in which the paper stock is jetted onto a cylindrical screen. These production processes are known, for example, from WO 2006/099971 A2 for the production of security documents or documents of value, such as banknotes or ID cards, and are also methods that are preferred in accordance with the invention for production of a GDL from at least one paper web.

For instance, the green paper having a high level of metal powder and/or metal fiber filler is formed in one operation, and this is processed according to DE 10 2008 042 415 B3 with at least two different formulations to give a combined sinter paper having different properties. For the fuel cell, these are, for example, a thin ply having fine pores and a thicker ply having coarser pores. Porosity may also vary between two paper webs.

In a preferred embodiment, the first paper web has a higher density than the second paper web. The first paper web has, for example, a density of 3 g/cm³ to 10 g/cm³, the second a density of 1 g/cm³ to 5 g/cm³. More preferably, the first paper web is formed here by a finer paper fiber slurry than the second paper web, which correspondingly leads to finer pores in this subregion of the sinter paper.

The thickness of the first paper web is preferably 5 μm to 50 μm, more preferably 10 μm to 20 μm, and that of the second paper web is preferably 50 μm to 400 μm, more preferably 80 μm to 200 μm.

In a further preferred embodiment, further paper webs may be applied to the first and second paper webs. Either likewise in the wet area of a paper machine like the first and second paper webs or subsequently by laminating. It is possible here for all paper webs to have different porosity or different channel-type structures, for example with different length or different diameter. More preferably, paper webs of different porosity may be combined to form a paper stack with a porosity gradient. In this way, it is particularly advantageously possible to achieve more uniform gas distribution within the fuel cell.

It is also possible for one or more of the paper webs to accommodate additional channels for water transport in the form of a watermark. These ensure balanced water transport and have the particular advantage that the PEM cell is neither flooded nor dries out, since both have an adverse effect on the efficiency of the cell. In addition, water channels may also be used for sustained cooling of the cell.

In addition, it is particularly advantageous when a watermark is made in the first paper web and in the second paper web, where the structures of the watermark of the first paper web and of the watermark of the second paper web are not identical, but have exact mirror symmetry in the plane and in the direction of material thickness. In other words, the structures of the watermark of the first paper web are phase-shifted by 180° relative to the structures of the watermark of the second paper web. This means that, when the first paper web and the second paper web are joined on their sides structured by the watermark, the elevations of the first paper web will coincide with the depressions of the second paper web. This embodiment has the particular advantage that the first and second paper webs may have different porosity after sintering. For example, the first paper web facing the membrane has a lower porosity of 20% to 75% after sintering, and the second paper web has a higher porosity of 30% to 90% after sintering, such that the second paper web barely acts as a barrier to the gas, but acts merely as a spacer to the bipolar plate. In this way, optimal gas distribution may be combined with optimal stackability and optimally uniform distribution of the mechanical pressure over the entire PEM membrane. Particularly advantageously, between the first paper web and the membrane, there is a microporous layer (MPL) having a fine surface with low roughness and smaller pores than the first and second paper webs.

A watermark in the context of this invention is a true watermark, where the thickness of the paper varies, but the density of the paper does not vary. The paper here has regions having a greater and/or lower thickness compared to the adjacent regions, although the density of the paper is the same in all regions. Such a watermark may be introduced into the paper web either in the course of papermaking, in that, for example, depressions or elevations are included in a cylindrical screen, at which there is greater or lesser accumulation of paper fibers in the creation of the paper from the pulp. However, it can also be introduced into the paper web subsequently, in that parts of the paper are removed, for example mechanically by machining or by lasering.

Alternatively, an artificial watermark is also possible, where the still-wet paper web is embossed by an embossing operation after the paper web has been removed, for example, from the cylindrical screen. Such a watermark is also referred to as a dandy roller watermark. The embossing reduces the thickness of the paper, although the density of the paper is simultaneously increased. The paper fibers are thus densified or compressed. This densification has the advantage that it prevents too much gas from diffusing directly through the GDL in the forward region of the channel toward the catalyst layer (CL), and hence ensures more uniform gas distribution.

More preferably, a true watermark and an artificial watermark may be combined with one another, in that, for example, parts of a watermark are formed by a true watermark and other parts by an artificial watermark.

The fuel cell is more preferably a proton exchange membrane fuel cell (PEMFC) or a proton exchange membrane electrolyzer cell (PEMEC) fu. In a preferred embodiment, the first paper web here forms a diffusion layer for a membrane (CL) coated with catalytic metal, preferably platinum, in the gas diffusion layer produced from the green paper, and the second paper web forms a distribution layer with a flow field in the gas diffusion layer produced from the green paper. The GDL produced from a green paper of the invention may, however, also be used for other kinds of fuel cell or other power-to-X technologies that require a porous conductive layer for gas/power/reactant distribution, for example electrolyzer cells.

The paper web consists, inter alia, preferably of paper made from cellulose fibers or made from cotton fibers, as used, for example, for banknotes, or from other natural fibers or from synthetic fibers or from a mixture of natural and synthetic fibers. Also preferably, the paper web consists of a combination of at least two different substrates arranged one on top of another and bonded to one another, called a hybrid. Details of the weight of the paper web used are given, for example, in document DE 102 43 653 A9, the details of which in this regard are fully incorporated into this application. The metal-filled green paper may have a gram weight of 100 g/m² to 1200 g/m².

In order to protect the metals from corrosion down to the smallest pores, and to produce the usually desirable hydrophobic properties preferentially on the side facing the catalyst, in a further preferred embodiment, a (thermal) ALD coating or other coating methods is/are used in one of the subsequent process steps. Preferably after the debindering and sintering and before the punching and finishing of the GDL, if the cuts are outside the region at risk of corrosion, or the cuts are sealed specially in the further process steps to give the finished cell. Otherwise, it is also possible to coat the GDL after the stamping and finishing by ALD, etc.

It will be apparent that the aforementioned features and the features still to be elucidated hereinafter are usable not just in the combinations specified, but also in other combinations, without leaving the scope of the present invention, provided that it is covered by the scope of protection of the claims.

The advantages of the invention are elucidated by the working examples which follow and the supplementary figures. The working examples are preferred embodiments, but there is no intention whatsoever that the invention be restricted thereto. Furthermore, the diagrams in the figures, for better understanding, are highly schematized and do not reflect the true circumstances. In particular, the proportions shown in the figures do not correspond to the true ratios and serve exclusively to improve clarity. Furthermore, the embodiments described in the working examples which follow, for better understanding, are reduced to the essential core information. In practical implementation, much more complex patterns or images may be employed.

### THE FIGURES SPECIFICALLY SHOW, IN SCHEMATIC FORM

FIG. 1 a schematic diagram of a double cylinder paper machine for production of a green paper of the invention,

FIG. 2 a paper machine with a cylindrical paper machine and a short former in a schematic diagram.

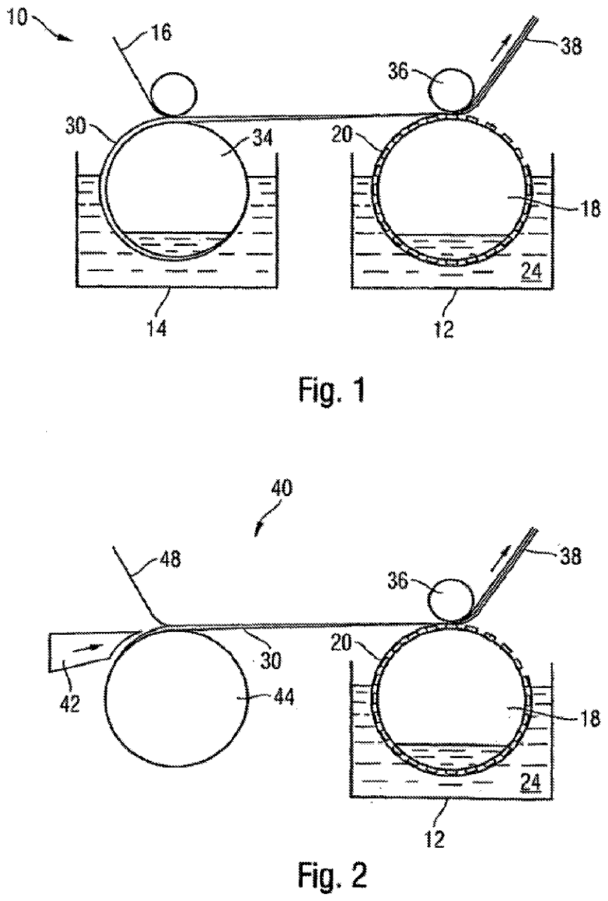

FIG. 1 shows, in a schematic diagram, a double-cylinder paper machine 10, as known, for example, from WO 2006/099971 A2 for the production of security paper. The paper machine 10 contains two cylindrical paper machines 12 and 14, which are connected to one another via a transfer felt 16.

In the first paper machine 12, a paper web 20 is formed on a cylindrical screen 18. In the second paper machine 14, in parallel, a second, homogeneous paper web 30 is produced, removed from the cylindrical screen 34 by means of the transfer felt 16, and guided to the first paper machine 12, where it is combined with the first paper web 20 in the region of the contact roll 36. The combined paper webs 38 collectively form the GDL and are sent to further processing stations.

The second paper web 30 may, as shown in FIG. 2, also be produced with a short former 40 in which the paper stock is jetted onto the surface of a cylindrical screen 44 with a headbox nozzle 42. Such a short former can be used to produce particularly thin paper plies, for example with a gram weight of 15 to 25 g/m².

It will be apparent that the paper machines 12, 14, 40 shown can also be used in an analogous manner to produce and combine three or more paper webs.

1-9. (canceled)

10. A process for producing a green paper for production of a gas diffusion layer (GDL) for a fuel cell,
wherein a first paper web is formed and a second paper web is formed, and the latter, in the still-moist state, is combined with and firmly bonded to the first paper web, where the first paper web and the second paper web together form the green paper.

11. The process according to claim 10, wherein the first and/or second paper web is produced in a cylindrical paper machine.

12. The process according to claim 10, wherein the first and/or second paper web is produced in a short former in which the paper stock is jetted onto a cylindrical screen.

13. The process according to claim 10, wherein the first paper web has a higher density than the second paper web, the first paper web having a density of 3 g/cm³ to 10 g/cm³, and the second paper web a density of 1 g/cm³ to 5 g/cm³.

14. The process according to claim 13, wherein the first paper web is formed by a finer paper stock slurry than the second paper web.

15. The process according to claim 10, wherein the first and/or second paper web includes added metal powders and/or metal fibers.

16. The process according to claim 10, wherein the fuel cell is a proton exchange membrane fuel cell (PEMFC), a proton exchange membrane electrolyzer cell (PEMEC), an electrolyzer cell or another power-to-x technology which requires correspondingly porous conductive material for gas/stream/reactant distribution.

17. The process according to claim 10, wherein the first paper web in the gas diffusion layer (GDL) produced from the green paper forms a diffusion layer for a membrane (CL) coated with catalytic metal, platinum, and the second paper web in the gas diffusion layer (GDL) produced from the green paper forms a distribution layer with a flow field.

18. The process according to claim 10, wherein a watermark is made in the first paper web and in the second paper web, where the structures of the watermark in the first paper web and of the watermark in the second paper web are not identical but have exact mirror symmetry in the plane and in the direction of material thickness.
